(19) United States
(12) Patent Application Publication
(10) Pub. No.: US 2013/0063482 A1
(43) Pub. Date: Mar. 14, 2013

(54) APPLICATION PROGRAMMING INTERFACE FOR A BITMAP COMPOSITION ENGINE

(71) Applicants: Silvana Moncayo, Seattle, WA (US); Leonardo Blanco, Redmond, WA (US); Reiner Fink, Mercer Island, WA (US); Imran Majid, Redmond, WA (US); Meng Yang, Bellevue, WA (US); Jonathan Liperi, Redmond, WA (US); Daniel Rischar, Snohomish, WA (US); Aleksandar Antonijevic, Bellevue, WA (US); Joshua Priestley, Redmond, WA (US)

(72) Inventors: Silvana Moncayo, Seattle, WA (US); Leonardo Blanco, Redmond, WA (US); Reiner Fink, Mercer Island, WA (US); Imran Majid, Redmond, WA (US); Meng Yang, Bellevue, WA (US); Jonathan Liperi, Redmond, WA (US); Daniel Rischar, Snohomish, WA (US); Aleksandar Antonijevic, Bellevue, WA (US); Joshua Priestley, Redmond, WA (US)

(73) Assignee: Microsoft Corporation, Redmond, WA (US)

(21) Appl. No.: 13/229,810

(22) Filed: Sep. 12, 2011

(51) Int. Cl. G06T 1/00; G09G 5/00; G09G 5/39

(52) U.S. Cl. 345/620; 345/522

(57) ABSTRACT

An application programming interface is provided by an operating system that includes a direct composition engine. The composition engine maintains a data structure that represents the display objects to be rendered on a desktop display. The application programming interface allows an application to write data to the data structure to update the display object, such as a window, for the application. Thus, multiple applications can update their respective display objects in this data structure. The direct composition engine is an operating system level process, presented to user-level processes as a service of the operating system. By having an operating system level process, performance standards can be maintained. The application programming interface also allows applications to provide display information that can be rendered more efficiently by the operating system than by the application.

### BACKGROUND

A user interface on a typical computer system includes a display through which information from a variety of applications is presented to the user on a display device. A typical display is called a “desktop,” which includes a background on which a variety of display objects are displayed. The display objects can be icons, toolbars, application windows and the like. The display objects typically overlap, so that one display object might partially or completely occlude another display object.

When generating the display, the computer system receives information from several applications. Each application can have, for example, a “window,” in which information from that application is displayed. The user or the computer system can adjust the position of the windows and other display objects on the desktop, typically independently of the applications themselves. Given the position, size and orientation of different display objects, the display that the user sees can be drawn or rendered and displayed on the display device.

There are several challenges in designing a computer system that provides a desktop display with multiple windows from multiple applications. For example, changes in the display, such as moving a window, should occur smoothly. As another example, decisions need to be made about which functions are performed by an application, and which functions are performed by a display system that receives data from multiple applications.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

An application programming interface is provided by an operating system that includes a direct composition engine. The direct composition engine maintains a data structure that represents the display objects to be rendered on a desktop display. The application programming interface allows an application to write data to the data structure to update the display object, such as a window, for the application. Thus, multiple applications can update their respective display objects in this data structure. The direct composition engine is an operating system level process, presented to user-level processes as a service of the operating system. By having an operating system level process, performance standards can be maintained. The application programming interface also allows applications to provide display information that can be rendered more efficiently by the operating system than by the application.

The data structure maintained by the direct composition engine is a tree of objects herein called visuals, with one or more visuals per each application's window. Thus, each application window is represented by a root node connected to a collection of visuals in the main composition tree.

Further, the direct composition engine can expose a set of interfaces to applications for use by developers to create visuals, bind them to a bitmap and manipulate different visual properties to achieve the desired user interface composition and animation scenarios. Examples of the visual properties include, but are not limited to, two dimensional (2D) transformations (which may include a series of transformations), clip, e.g., a rectangular clip, bitmap effect (or group of effects), and bitmaps (which can be configured in a variety of ways).

A 2D transformation can be used to modify a coordinate system of a visual relative to its parent. When visuals are deeply nested, the transformations of those visuals can be composed via matrix multiplication. A variety of different 2D transformations can be supported by the global composition system, such as translations, scales, rotations and skews. In addition, the application can specify arbitrary affine transformations, e.g., by using an explicit 3×2 matrix, can build more complex compound transformations using a transform group (which is simply an army of transformations), and so on.

A clip can be used to restrict a set of pixels that a visual sub-tree may affect. In one or more implementations, clips are defined rectangular regions, which may have optionally rounded corners.

The composition engine can support a variety of different bitmap effects and bitmap formats.

The application programming interface allows an application to create, modify and delete a display object (visual) in the tree of display objects for the application. In addition, any of the attributes, such as a position, opacity, clip parameters and a bitmap, of a display object can be modified.

Accordingly, in one aspect, which can be embodied as an article of manufacture or a computing machine, is an operating system through which an application accesses resources of the computing machine. This operating system provides a composition engine having an input that receives a data structure describing data from a plurality of applications to be rendered to a display, and an output that provides display data. The data structure is stored in memory, and stores, for each application, a tree of visuals including a plurality of display objects each defined by at least a bitmap, position and image processing parameters, such as transform, effects, clipping and opacity parameters. A library accessible by the applications provides an application programming interface through which the applications can modify the data structure with data to be displayed from the applications.

In one implementation, the library includes a function for creating a composition device object that manages interaction with the direct composition engine. The composition device object can include create methods for creating each of a plurality of visual objects. The library can include visual objects, each with methods of setting parameters of the visual object. The methods for setting parameters can queue changes to the data structure. The composition device object can include a method for allowing an application to commit changes to the data structure, in response to which such changes are made to the data structure and the display objects are rendered to the display. The composition device can include a data structure for maintaining frame statistics. The composition device can include a method callable by an application to provide the frame statistics to the application.

In the following description, reference is made to the accompanying drawings which form a part hereof, and in which are shown, by way of illustration, specific example implementations of this technique. It is understood that other embodiments may be utilized and structural changes may be made without departing from the scope of the disclosure.

### DESCRIPTION OF THE DRAWINGS

FIG. 1 is a block diagram of an application environment in which multiple applications utilize an operating system service for rendering the desktop.

FIG. 2 is a diagram illustrating an example data structure representing a tree of visuals.

FIG. 3 is a diagram illustrating structure of an example implementation of this interface.

FIG. 4 is a flow chart describing operation of an application using an example implementation of the interface.

FIG. 5 is a flow chart describing operation of an example implementation of the interface.

FIG. 6 is a block diagram of an example computing device in which such a system can be implemented.

### DETAILED DESCRIPTION

The following section provides an example operating environment in which this interface can be implemented.

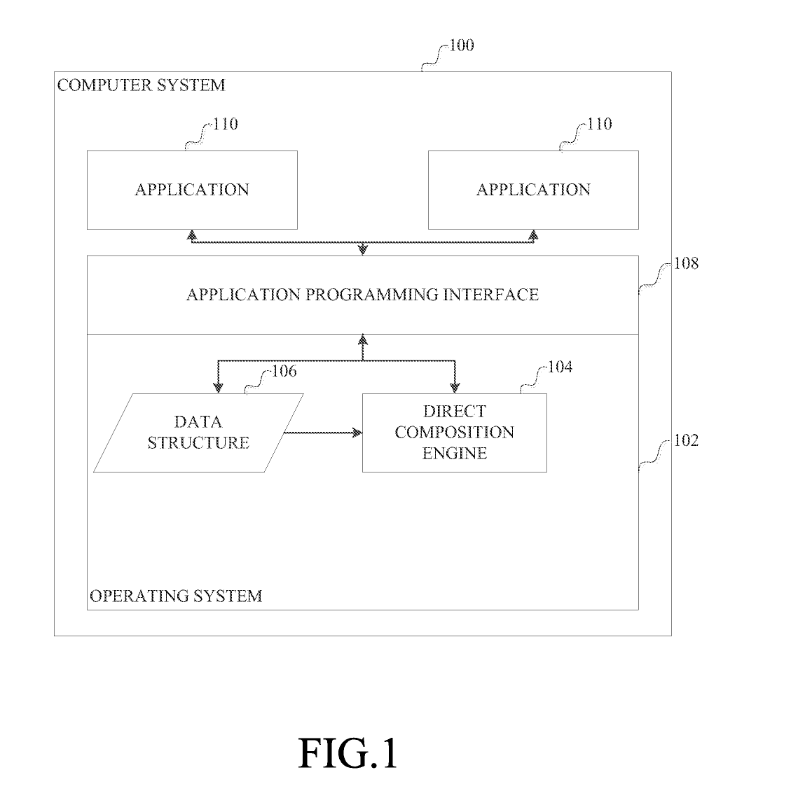

Referring to FIG. 1, a computer system 100 includes an operating system 102 that includes a direct composition engine 104. The direct composition engine is an operating system level process, presented to user-level processes as a service of the operating system. By having an operating system level process, performance standards can be maintained. The direct composition engine 104 maintains a data structure 106 that represents display objects to be rendered on a display device. The rendered objects are commonly referred to as a “desktop.” For example, the desktop may include several icons, application windows, tool bar or other user interface items rendered on a background.

Access to the data structure 106 is provided through an application programming interface 108. One or more applications 110 running on the computer system 100 render objects on the display by updating the data structure 106, which in turn is rendered by the direct composition engine 104 to update the display.

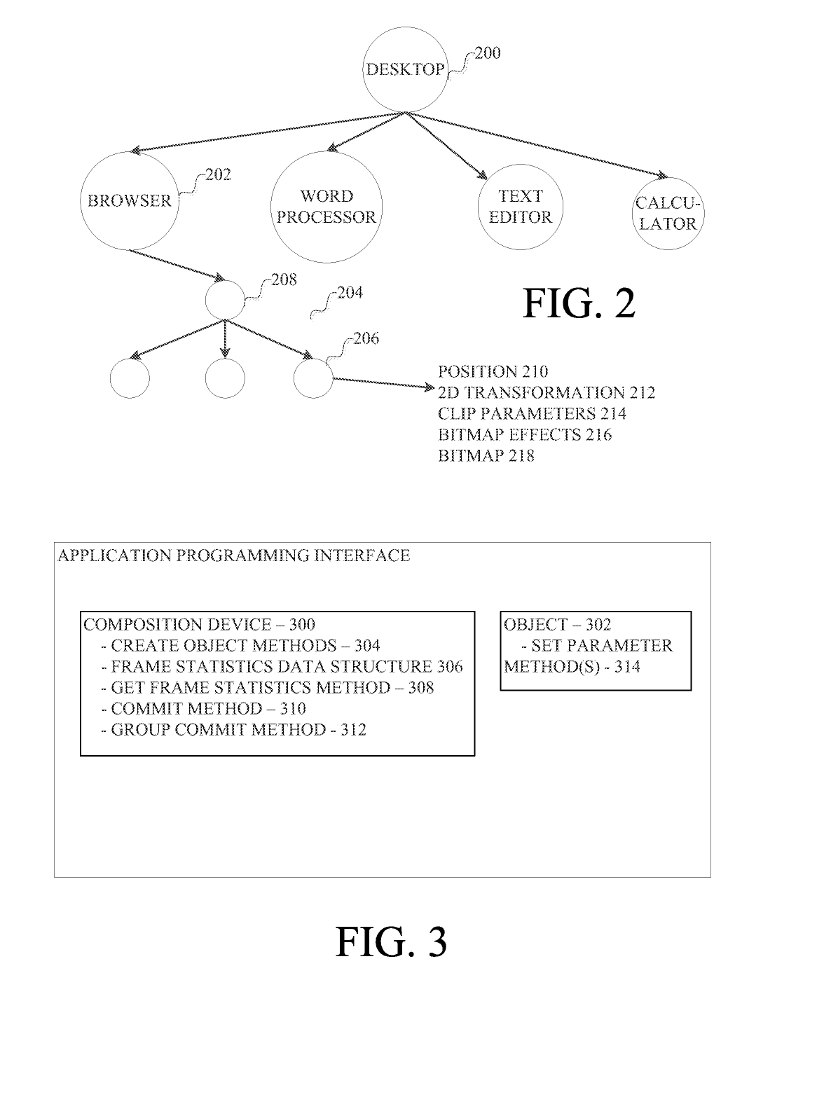

Given this context, an example implementation of this interface will be described in more detail in connection with FIGS. 2-4.

FIG. 2 illustrates an example data structure for representing the desktop. In this example, the data structure maintained by the direct composition engine is represented as a tree, with a root node 200 representing the desktop. The other nodes each represent a window 202 for an application, such as a browser, word processor, text editor, calculator, etc. A window, such as the browser window, can contain a tree 204 of objects 206 herein called visuals, with one or more visuals per each application's window. Thus, each application window refers to a root node 208 of a tree of visuals.

Each display object has a set of visual properties that are exposed through a set of interfaces to applications. The interfaces enable developers to create visuals, bind them to a bitmap and manipulate different visual properties to achieve the desired user interface composition and animation scenarios. Examples of the visual properties include, but are not limited to, a position 210, two dimensional (2D) transformations 212, clip parameters 214, bitmap effects 216, and a bitmap 218.

The position specifies the relative position of the display object with respect to an origin specified for the window. The bitmap 218 is the data to be drawn and many types of representations can be supported. In the composition engine, the 2D transformations, clip parameters and bitmap effects are applied to the bitmap, and the result is placed at the specified position in the window.

A 2D transformation can be used to modify a coordinate system of a visual relative to its parent. When visuals are deeply nested, the transformations of those visuals can be composed via matrix multiplication. A variety of different 2D transformations can be supported by the global composition system, such as translations, scales, rotations and skews, in addition, the application can specify arbitrary affine transformations, e.g., by using an explicit 3×2 matrix, can build more complex compound transformations using a transform group (which is simply an array of transformations), and so on.

A clip can be used to restrict a set of pixels that a visual sub-tree may affect. In one or more implementations, clips are defined rectangular regions, which may have optionally rounded corners.

The composition engine can support a variety of different bitmap effects, examples of which include three dimensional perspective transformations, constant-alpha opacity, and Porter-Duff compositional blend modes. A bitmap effect can have a semantic of replacing a visual sub-tree by a single visual referencing an off-screen texture that contains the rasterization of the original sub-tree. The effect then can be applied when the off-screen texture is blended back to a composition target. In practice, the composition engine can avoid off-screen rasterization in some scenarios, but may also be used for correct rendering. Thus, the effects may not be made available in one or more implementations as a direct property on the visual, e.g., like 2D transformations. Thus, in this implementation a developer sets an effect property first and then may set any of its classes.

Bitmaps may be configured in a variety of ways, such as to have a 32 bits per pixel (bpp) pixel format, which may include eight bits for per-pixel transparency. However, the application also can specify how the global composition system is to consume the alpha channel. In particular, the composition engine may ignore alpha altogether, in which case the bitmap is considered fully opaque, or it can use the alpha channel assuming the colors are either pre-multiplied or not pre-multiplied. The application programming interface allows an application to create, modify and delete a display object (visual) in the tree of display objects for the application. In addition, any of the attributes, such as a position, opacity, clip parameters and a bitmap, of a display object can be modified.

Given this data structure, each tree of display objects can be rendered using conventional application composition techniques. However, by having the composition performed by an operating system level process, providing a user-level service, performance standards can be maintained.

An example implementation of the application programming interface 108 in FIG. 1 will now be described in more detail in connection with FIGS. 3-5. The application programming interface 108 allows other applications to manipulate the data structure 108, by allowing a programmer to write the application using commands consistent with the application programming interface. It is itself a set of computer programs, implemented as a library, which can be accessed by an application that conforms to the API.

In one implementation, this library is implemented as an object oriented application programming interface, including several objects.

The primary object is the “composition device” 300 which is the interface to the composition engine. Through it, other objects 302 are created, and transactional composition is controlled. A “create device” function is provided to create a new composition device object. After a composition device is created, its methods 304 can be called to create other objects.

The composition device includes a frame statistics data structure 306, which is used to describe timing and composition statistics for a frame. Such a data structure can include data such as a last frame time, which is a time stamp of the last batch of commands to be processed by the composition engine. The current composition rate also can be stored, which is the rate at which the composition engine is producing frames, in frames per second. The current time and the units in which the last frame time and current are specified also can be stored.

The fields of this structure are filled in by a “Get Frame Statistics” method 308 of the composition device, at the time the method is called. This method returns timing information about the composition engine which can be used to synchronize animations done by the composition engine with animations done by an application. An application can use the last frame time, the current time, the current composition rate and the time frequency to estimate the timestamp of the next few frames to be started by the composition engine. While the composition engine may or may not compose the next frame, depending on whether or not there are active animations or other work submitted for that frame, this value is still useful as an estimate. In addition, the composition engine may change frame rates according to the cost of composing individual frames.

The composition device also has a commit method 310. Using this library, all calls through this application programming interface are held until the commit method of the composition device is called. In other words, “set” methods for parameters of various objects actually queue changes to be made to the data structure; when the commit method is called, this queue of changes is processed to update the data structure. Thus, all changes to a display for an application are processed at one time by the composition device, to update the data structure representing the display, and then are rendered by the direct composition engine.

If an application uses multiple composition devices, it may commit them separately, in which case they are processed individually and the commits may or may not take effect at the same frame. To enable multiple device commits to be processed atomically, another method called “group commit” 312 can be implemented. This method commits all commands pending on several composition devices atomically. The parameters of this method include an array of composition device interface pointers specifying a set of devices to commit at the same time, and a number of elements of that array.

A composition device also includes methods 304 for creating the other objects 302 used in a composition. A “create” method for the kind of object is called, returning a default instance of the desired object, in the context of the composition device.

After an object is created, the object can be modified by calls to methods associated with that object. For example, given a “visual,” “set” 314 methods are available for setting a variety of parameters of the visual including, but not limited to, its position (offsets x and y for example), clipping, opacity, content or bitmap, border mode, interpolation mode and other parameters. A visual also may have methods for adding and removing visuals.

Any transform, clipping, effect or other object can be defined to have “set” methods that set the parameters of that object.

For example, a translate transform object can have methods to set offset parameters in the x and y directions. A scale transform object can have methods to set scaling and center parameters in the x and y directions. A rotate transform object can have methods for setting an angle parameter and center parameters in the x and y direction. A skew transform object can have methods for setting angle and center parameters in the x and y direction. A matrix transform object can have a method for setting matrix values for a transform. Such transform effects can be implemented in three dimensions as well.

An effect object can have methods to set opacity, blending mode, border mode, interpolation mode and transform parameters.

Clipping objects can have methods defining the shape of the clipping object, such as the left, top, right and bottom dimensions (if rectangular) and a radius for each corner of the object (if the rectangle contains rounded borders).

An animation object can have methods for setting the timing of animations, such as a start time, animation curves, repeats and end times. Most of the parameters (e.g., offset parameters of a translate transform) can be animated through this application programming interface by assigning them an animation object. That is, when animating the start time\value, end time\value, etc., are not specified on the parameter itself, but rather on the animation object, which is set on the parameter. Thus, this interface provides a mechanism through which applications can create composition devices, bind them to windows, and then create and set parameters for visual objects.

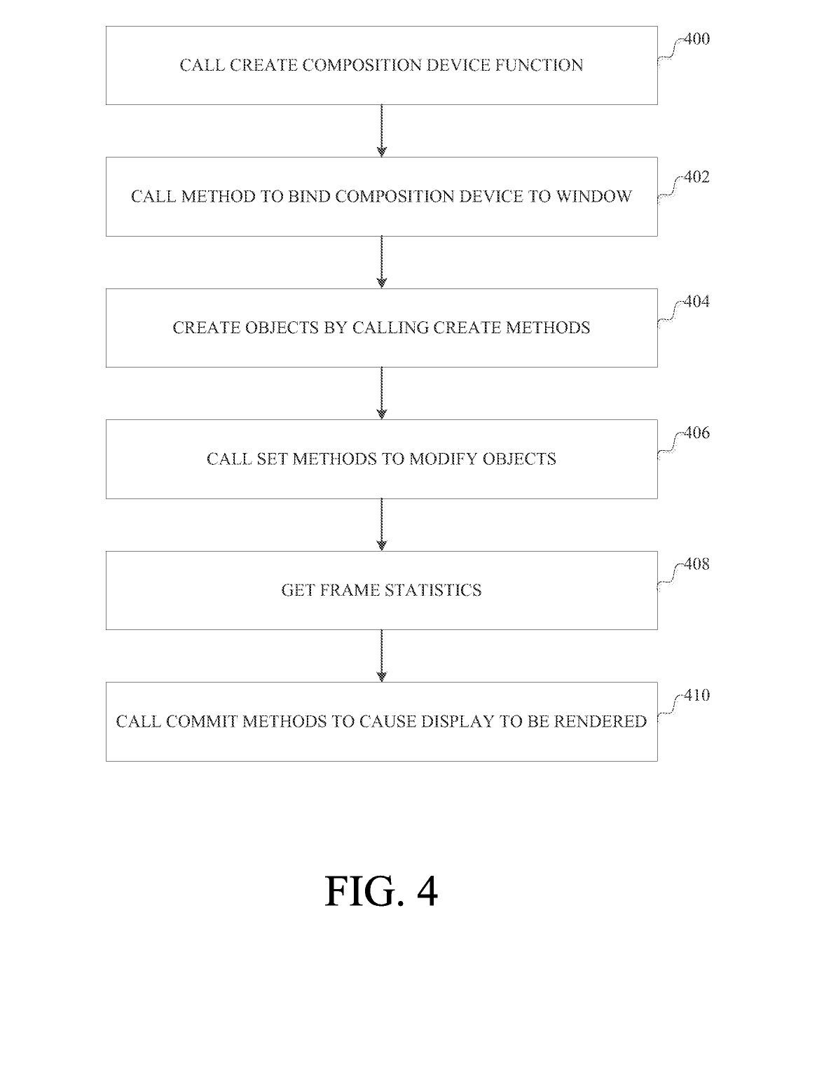

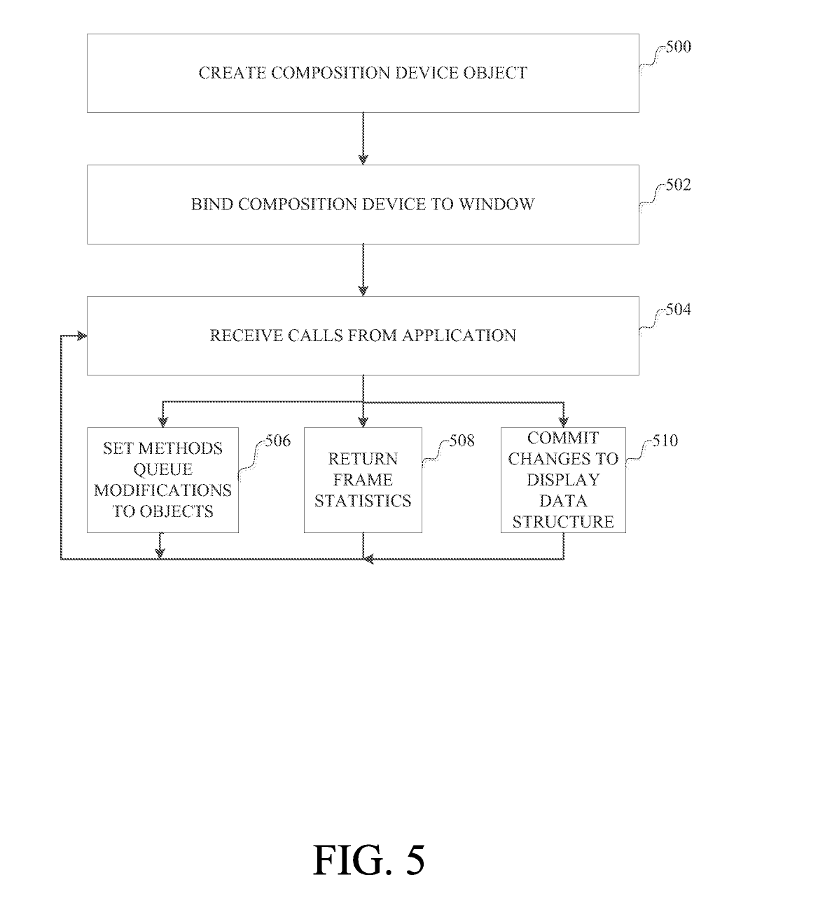

Given this understanding the operations of an application and the library will now be described in connection with FIGS. 4 and 5.

FIG. 4 describes steps that would occur in an application using such a library. An application calls 400 the function to create a composition device. Next it calls 402 the method to bind this composition device to one of the windows belonging to the application. Visual objects then can be created 404 by the application and modified 406 using the ‘set’ methods of those objects, as needed by the application. The application uses the get frame statistics method 408 of the composition device to obtain information useful in determining the timing of commit operations. At various intervals determined from this information, the application calls 410 the commit method of the composition device to cause data to be rendered to the display. This sequence of processing by the application, modifying objects and committing such modifications, continues while the application is running.

FIG. 5 describes operation of the library and direct composition engine being used by the application. In response to the function call from an application, a composition device object is created 500 and a pointer to this object is returned to the application. When the method is called to bind the composition device to the window, the binding is made 502 (if the window belongs to the application calling the method), and an indication of whether this operation was successful is returned to the application. As the application makes various calls to methods of the composition device and related objects, as indicated at 504, calls to methods that create and modify objects are queued 506 until a commit method is called. If the application makes a call to get frame statistics, these statistics are computed 508 and then returned to the application. When a commit method is called, the queued calls are processed. 510 at once to update the display data for the application, after which the data structure maintained by this interface is rendered to the display.

Having now described an example implementation, a computing environment in which such a system is designed to operate will now be described. The following description is intended to provide a brief, general description of a suitable computing environment in which this system can be implemented. The system can be implemented with numerous general purpose or special purpose computing hardware configurations. Examples of well known computing devices that may be suitable include, but are not limited to, personal computers, server computers, hand-held or laptop devices (for example, media players, notebook computers, cellular phones, personal data assistants, voice recorders), multiprocessor systems, microprocessor-based systems, set top boxes, game consoles, programmable consumer electronics, network PCs, minicomputers, mainframe computers, distributed computing environments that include any of the above systems or devices, and the like.

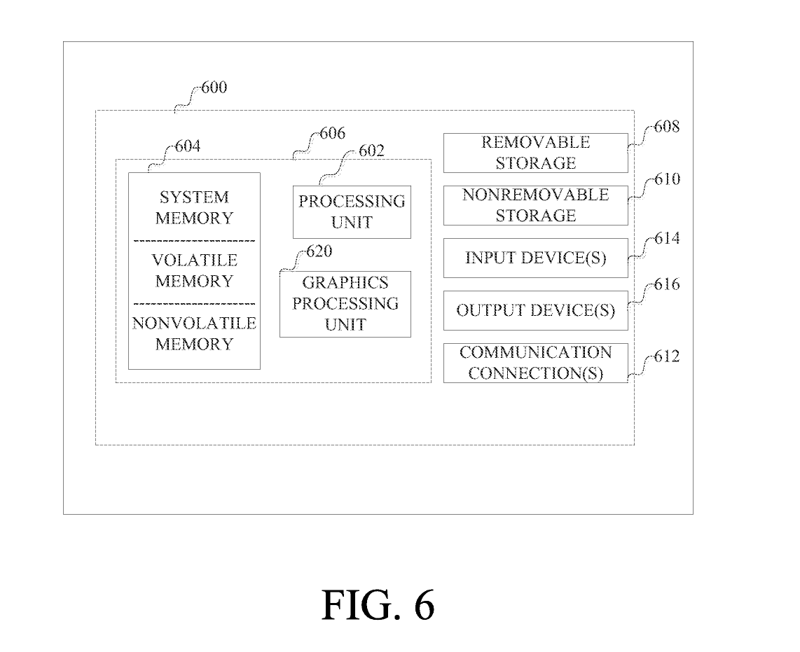

FIG. 6 illustrates an example of a suitable computing system environment. The computing system environment is only one example of a suitable computing environment and is not intended to suggest any limitation as to the scope of use or functionality of such a computing environment. Neither should the computing environment be interpreted as having any dependency or requirement relating to any one or combination of components illustrated in the example operating environment.

With reference to FIG. 6, an example computing environment includes a computing machine, such as computing machine 600. In its most basic configuration, computing machine 600 typically includes at least one processing unit 602 and memory 604. The computing device may include multiple processing units and/or additional co-processing units such as graphics processing unit 620. Depending on the exact configuration and type of computing device, memory 604 may be volatile such as RAM), non-volatile (such as ROM, flash memory, etc.) or some combination of the two. This most basic configuration is illustrated in FIG. 6 by dashed line 606. Additionally, computing machine 600 may also have additional features/functionality. For example, computing machine 600 may also include additional storage (removable and/or non-removable) including, but not limited to, magnetic or optical disks or tape. Such additional storage is illustrated in FIG. 6 by removable storage 608 and non-removable storage 610. Computer storage media includes volatile and nonvolatile, removable and non-removable media implemented in any method or technology for storage of information such as computer program instructions, data structures, program modules or other data. Memory 604, removable storage 608 and non-removable storage 610 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by computing machine 600. Any such computer storage media may be part of computing machine 600.

Computing machine 600 may also contain communications connection(s) 612 that allow the device to communicate with other devices. Communications connection(s) 612 is an example of communication media. Communication media typically carries computer program instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal, thereby changing the configuration or state of the receiving device of the signal. By way of example, and not limitation, communication media includes wired media such as a wired network or direct-wired connection, and wireless media such as acoustic, RF, infrared and other wireless media.

Computing machine 600 may have various input device(s) 614 such as a keyboard, mouse, pen, camera, touch input device, and so on. Output device(s) 616 such as a display, speakers, a printer, and so on may also be included. All of these devices are well known in the art and need not be discussed at length here.

This application programming interface can be implemented in the general context of software, including computer-executable instructions and/or computer-interpreted instructions, such as program modules, being processed by a computing machine. Generally, program modules include routines, programs, objects, components, data structures, and so on, that, when processed by a processing unit, instruct the processing unit to perform particular tasks or implement particular abstract data types. This system may be practiced in distributed computing environments where tasks are performed by remote processing devices that are linked through a communications network. In a distributed computing environment, program modules may be located in both local and remote computer storage media including memory storage devices.

The terms “article of manufacture”, “process”, “machine” and “composition of matter,” if present in the preambles of the appended claims, are intended to limit the claims to subject matter deemed to fall within the scope of patentable subject matter defined by the use of these terms in 35 U.S.C. §101.

Any or all of the aforementioned alternate embodiments described herein may be used in any combination desired to form additional hybrid embodiments. It should be understood that the subject matter defined in the appended claims is not necessarily limited to the specific implementations described above. The specific implementations described above are disclosed as examples only.

What is claimed is:

1. An article of manufacture comprising:
one or more computer storage media;
computer program instructions stored on the computer storage media which, when processed by a processing device, instruct the processor to perform operations, wherein the instructions include operations that provide an operating system through which an application accesses resources of the computing machine, wherein the operating system provides:
a composition engine having an input that receives a data structure describing data from a plurality of applications to be rendered to a display, and an output that provides display data;
the data structure being stored in memory, and storing, for each application, a tree of visuals including a plurality of display objects each defined by at least a bitmap, a position, and image processing parameters; and
a library accessible by the applications and providing an application programming interface through which the applications can modify the data structure with data to be displayed from the applications.

2. The article of manufacture of claim 1, wherein the library includes a function for creating a composition device object that manages interaction with the direct composition engine.

3. The article of manufacture of claim 2, wherein the composition device object includes create methods fir creating each of a plurality of visual objects.

4. The article of manufacture of claim 3, wherein the library includes visual objects, each with methods of setting parameters of the visual object.

5. The article of manufacture of claim 4, wherein the methods for setting parameters queue changes to the data structure, and wherein the composition device object includes a method for allowing an application to commit changes to the data structure, in response to which such changes are made to the data structure and the display objects are rendered to the display.

6. The article of manufacture of claim 2, wherein the composition device object includes a method for allowing an application to commit changes to the composition device in response to which such changes are made to the data structure and the display objects are rendered to the display.

7. The article of manufacture of claim 2, wherein the composition device includes a data structure for maintaining frame statistics, and wherein the composition device includes a method callable by an application to provide the frame statistics to the application.

8. The article of manufacture of claim 7, wherein the composition device object includes a method for allowing an application to commit changes to the composition device in response to which such changes are made to the data structure and the display objects are rendered to the display.

9. The article of manufacture of claim 1, wherein the image processing parameters include at least one of clipping and transform parameters.

10. The article of manufacture of claim 1, wherein the image processing parameters include at least one of effect and opacity parameters.

11. A computing machine comprising:
a processor;
one or more computer storage media;
computer program instructions stored in the computer storage media that, when processed by the processor, instruct the processor to perform operations, wherein the instructions include operations that provide an operating system through which an application accesses resources of the computing machine, wherein the operating system provides:
a composition engine having an input that receives a data structure describing data from a plurality of applications to be rendered to a display, and an output that provides display data;
the data structure being stored in memory, and storing, for each application, a tree of visuals including a plurality of display objects each defined by at least a bitmap, position, and image processing parameters; and
a library accessible by the applications and providing an application programming interface through which the applications can modify the data structure with data to be displayed from the applications.

12. The computing machine of claim 11, wherein the library includes a function for creating a composition device object that manages interaction with the composition engine.

13. The computing machine of claim 12, wherein the composition device object includes create methods for creating each of a plurality of visual objects.

14. The computing machine of claim 13, wherein the library includes visual objects, each with methods of setting parameters of the visual object.

15. The computing machine of claim 14, wherein the methods for setting parameters queue changes to the data structure, and wherein the composition device object includes a method for allowing an application to commit changes to the data structure, in response to which such changes are made to the data structure and the display objects are rendered to the display.

16. The computing machine of claim 12, wherein the composition device object includes a method for allowing an application to commit changes to the composition device in response to which such changes are made to the data structure and the display objects are rendered to the display.

17. The computing machine of claim 12, wherein the composition device includes a data structure for maintaining frame statistics, and wherein the composition device includes a method callable by an application to provide the frame statistics to the application.

18. The computing machine of claim 17, wherein the composition device object includes a method for allowing an application to commit changes to the composition device in response to which such changes are made to the data structure and the display objects are rendered to the display.

19. The computing machine of claim 11, wherein the image processing parameters include at least one of clipping and transform parameters.

20. The computing machine of claim 11, wherein the image processing parameters include at least one of effect and opacity parameters.
